(19) United States
(12) Patent Application Publication
(10) Pub. No.: US 2020/0070393 A1
(43) Pub. Date: Mar. 5, 2020

(54) Movable Needle Valve of Hot-Runner Mold

(71) Applicant: Chung Hsien Lin, Taichung City (TW)

(72) Inventor: Chung Hsien Lin, Taichung City (TW)

(21) Appl. No.: 16/120,809

(22) Filed: Sep. 4, 2018

(51) Int. Cl. B29C 45/28

(52) U.S. Cl. CPC B29C 45/2806

(57) ABSTRACT

A hot-runner mold includes a body having a passage defined axially therethrough. A needle valve is movably inserted into the passage. A heating member is spirally mounted to outside of the body. A locking member is connected to the body. A material supply tube is located between the locking member and the room in the body. The material supply tube includes a through hole. A guiding unit is located at the distal end of the material supply tube. The guiding unit has an injection hole defined therethrough which communicates with the through hole. The hardness of the guiding unit is higher than that of the material supply tube and the needle valve. The injection hole is not worn out by the needle valve to prevent the injection hole from being expanded.

### BACKGROUND OF THE INVENTION

### 1. Fields of the Invention

The present invention relates to a movable needle valve, and more particularly, to a movable needle valve of a hot-runner mold to ensure that the injection hole of the material supply tube and the inlet of the mold set are not enclosed to form surplus material.

### 2. Descriptions of Related Art

The conventional needle valve of a hot-runner mold is disclosed in FIGS. 1 to 5, and includes a body 10 with a passage 100 defined axially therethrough, a needle valve 12 movably inserted into the passage 100, a heating member 11 spirally mounted to outside of the body 10, a locking member 13 connected to the body 10, and a material supply tube 14 located between the room 101 in the body 10 and the locking member 13. The material supply tube 14 includes a base 140 that extends from the room 101 of the body 10 to the locking member 13, a tubular body 141 extending from the base 140 and extending beyond the locking member 13, a room 142 located between the base 140 and the tubular body 141, and an injection hole 143 defined through the tubular body 141 and communicating with the room 142. When the distal end of the needle 120 of the needle valve 12 is applied by an inward force and drags the needle 120 into the room 142, the injection hole 143 of the material supply tube 14 is opened as shown in FIG. 3, and melted plastic material “b” flows through the injection hole 143 and enters into the cavity 21 of the mold set 2 until the plastic material “b” fills up the cavity 21. When the distal end of the needle 120 of the needle valve 12 is moved outward to let the distal end of the needle 120 of the needle valve 12 move along the inside of the material supply tube 14 and seals the inlet 20 of the mold set 2 and the injection hole 143 as shown in FIG. 2 to complete a plastic injection molding.

Because the distal end of the needle 120 of the needle valve 12 is moved from the inside of the injection hole 143 to the room 142 which is larger than the injection hole 143, so that distal end of the needle 120 of the needle valve 12 shifts a small distance due to temperature change, and the melted plastic material “b” also pushes the distal end of the needle 120 of the needle valve 12 toward the inside of the room 142 as shown in FIG. 3. When the needle valve 12 is to seal the inlet 20, the needle 120 is pushed outward and the distal end of the needle 120 is guided along the inside of the room 142 until the distal end of the needle 120 is inserted into the injection hole 143 and the inlet 20 of the mold set 2. In order to optimize the flowing feature of the melted plastic material “b” in the material supply tube 14, the material supply tube 14 is preferably made by copper which has limited hardness and wear resistance. However, the hardness and wear resistance of the needle 120 is higher than those of the material supply tube 14, so that the inside of the injection hole 143 and the inlet 20 will be worn off by the distal end of the needle 120 when sealing the injection hole 143 and the inlet 20. Specifically, there will be a gap “A” formed between the needle 120 and the inside of the injection hole 143 and the inlet 20 as show in FIG. 4. The melted plastic material “b” will flows through the gap “A” to form an irregular portion “C1” which causes defect to the product “C”, and extra laboring is required to remove the irregular portion “C1”.

Once the injection hole 143 and the inlet 20 are enlarged, as described to have the gap “A” formed between the needle 120 and the inside of the injection hole 143 and the inlet 20, the mold set 2 and the material supply tube 14 have to be maintained or replaced, and the manufacturing processes have to stop.

The present invention is intended to provide a movable needle valve of a hot-runner mold to avoid the injection hole of the material supply tube and the inlet of the mold set from being worn out and enlarged.

### SUMMARY OF THE INVENTION

The present invention relates to a movable needle valve of a hot-runner mold, and comprises a body having a passage defined axially therethrough. A room is defined in the body and communicates with the passage. A heating member is spirally mounted to outside of the body. A needle valve has a needle which is movably inserted into the passage. A locking member is connected to the body, and a material supply tube is located between the locking member and the room in the body. The material supply tube includes a base located between the locking member and the room. A tubular portion extends from the base and protrudes beyond the locking member. A through hole is defined through the base and the tubular portion. A guiding unit is located at the distal end of the material supply tube, and the guiding unit has an injection hole defined therethrough. The injection hole communicates with the through hole. The hardness of the guiding unit is higher than that of the material supply tube. Accordingly, when the needle moves within the guiding unit, the injection hole is not worn out by the needle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a partial cross sectional view of the conventional hot-runner mold with a needle valve;

FIG. 2 shows a cross sectional view of the circled portion in FIG. 1, wherein the melted plastic material has not yet entered into the cavity of the mold set;

FIG. 3 shows a cross sectional view of the circled portion in FIG. 1, wherein the melted plastic material has entered into the cavity of the mold set;

FIG. 4 shows a gap formed in the injection hole of the conventional hot-runner mold;

FIG. 5 shows the product with the irregular portion;

FIG. 6 is a perspective view to show the movable needle valve of the present invention;

FIG. 7 is an exploded view of the movable needle valve of the present invention;

FIG. 8 is a cross sectional view to show that the movable needle valve of the present invention is installed in the hot-runner mold;

FIG. 9 shows a cross sectional view of the circled portion in FIG. 8, wherein the melted plastic material has not yet entered into the cavity of the mold set;

FIG. 10 shows a cross sectional view of the circled portion in FIG. 8, wherein the melted plastic material has entered into the cavity of the mold set, and

FIG. 11 shows another embodiment of the guiding unit and the material supply tube of the present invention.

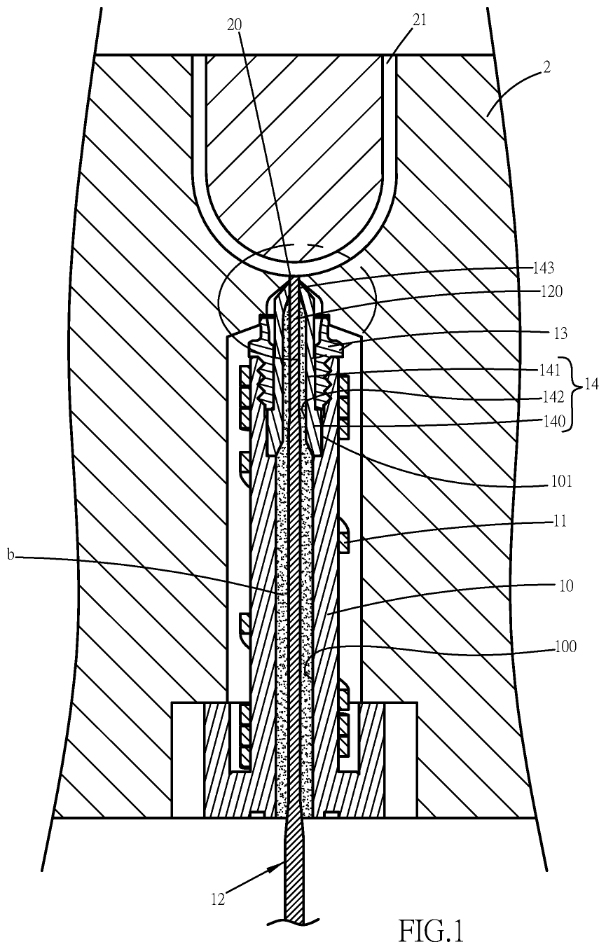

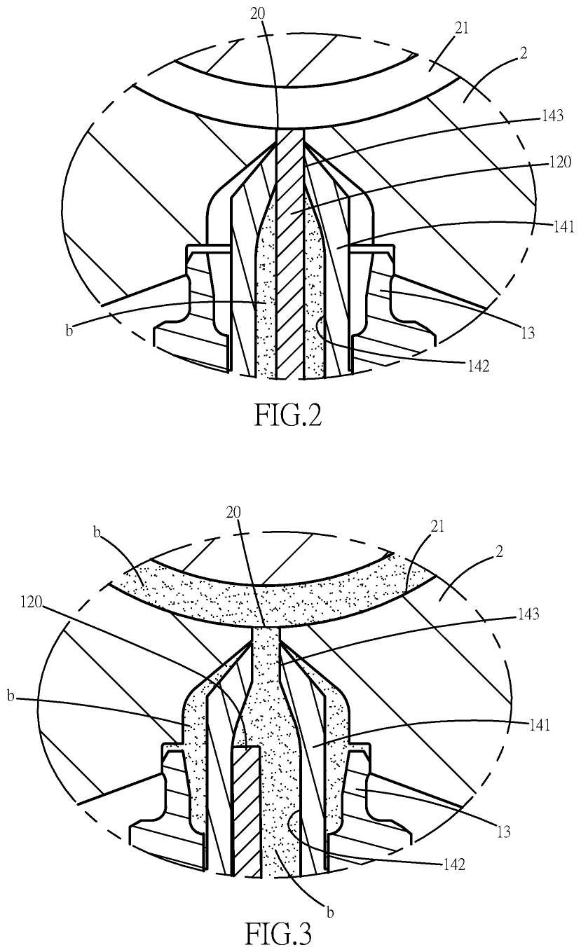

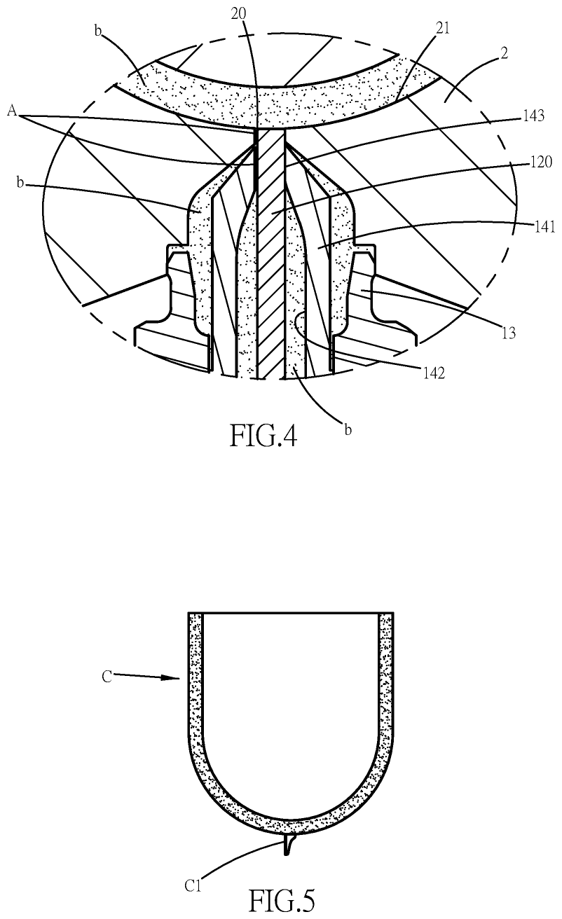

### DETAILED DESCRIPTION OF THE PREFERRED EMBODIMENT

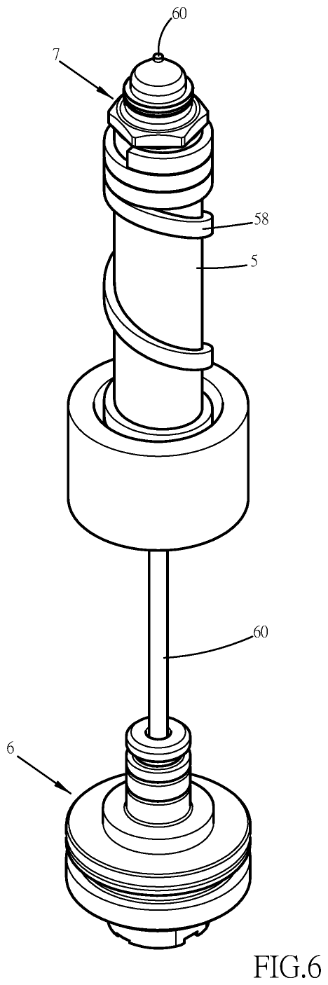

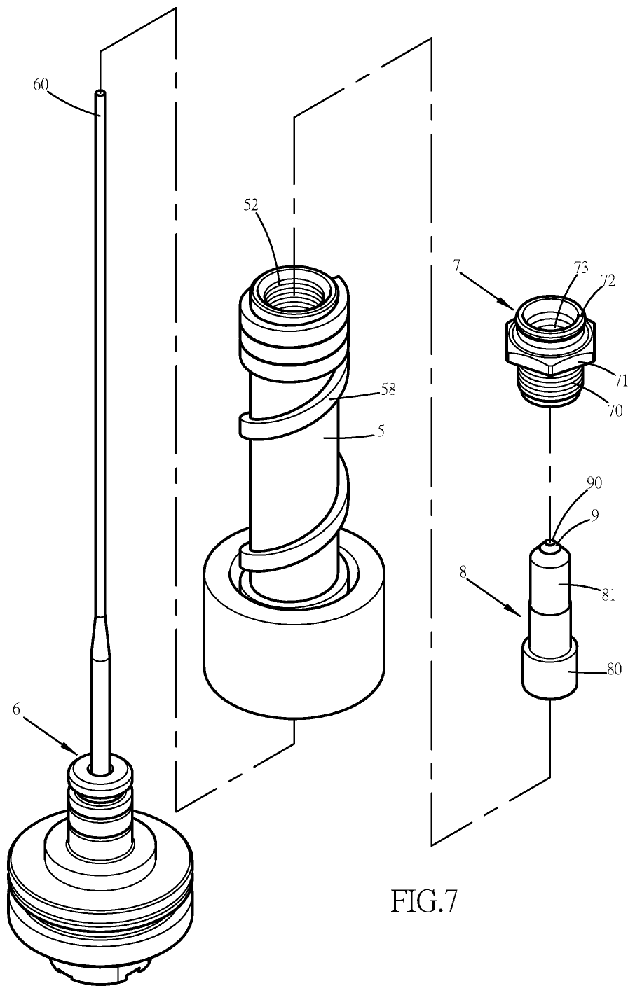

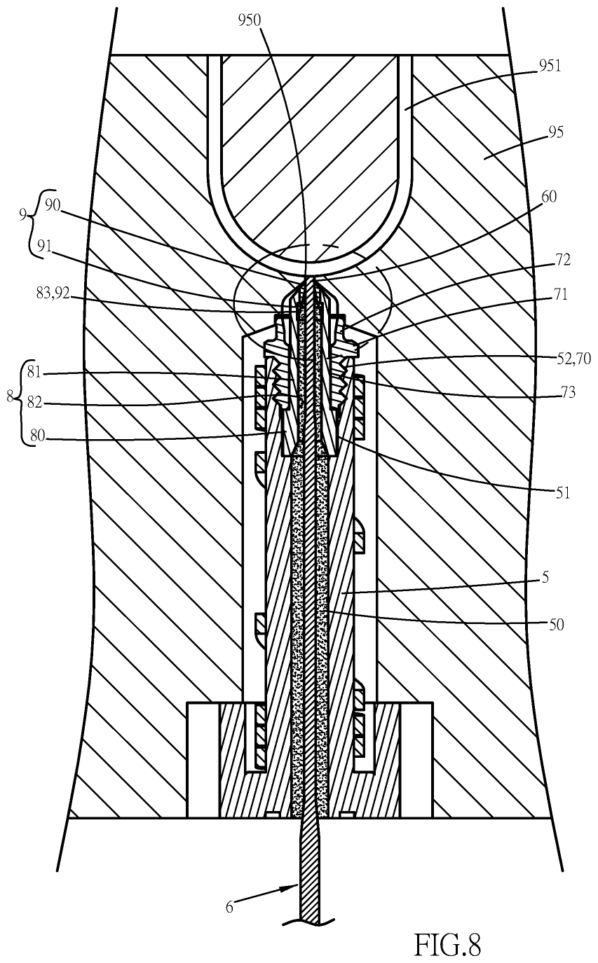

Referring to FIGS. 6 to 10, the movable needle valve for the hot-runner mold of the present invention comprises a body 5 having a passage 50 defined axially therethrough, a room 51 defined in the body 5 and communicating with the passage 50, a heating member 58 spirally mounted to outside of the body 5, a needle valve 6 having a needle 60 which is movably inserted into the passage 50, a locking member 7 connected to the body 5, and a material supply tube 8 located between the locking member 7 and the room 51 in the body 5.

The room 51 includes inner threads 52 defined therein, and the locking member 7 is threadedly connected to the inner threads 52 of the room 51. The needle 60 of the needle valve 6 and the melted plastic material are located within the passage 50. The base 80 of the material supply tube 8 is clamped between the room 51 of the body 5 and the lower end of the locking member 7. The passage 50 co-axially communicates with the through hole 82 of the material supply tube 8.

The needle 60 is movably inserted into the through hole 82 of the material supply tube 8 and the injection hole 90 of the guiding unit 9. The distal end of the needle 60 of the needle valve 6 normally seals the injection hole 90 of the guiding unit 9. The wearing resistance of the guiding unit 9 is higher than that of the material supply tube 8, and is not less than the wearing resistance of the needle 60 of the needle valve 6. The hardness and the wearing resistance of the needle 60 of the needle valve 6 are higher than those of the material supply tube 8.

The locking member 7 includes outer threads 70 which are threadedly connected to the inner threads 52 of the room 51. The locking member 7 has a flange 71 extending outward and radially therefrom so that the users may lock the locking member 7 by using a tool to clamp the flange 71 and rotate the locking member 7. An end lip 72 axially extends from the flange 71, and a space 73 is defined axially through the locking member 7. The tubular portion 81 extends through the space 73 so that the tubular portion 81 protrudes beyond the space 73 of the locking member 7.

The material supply tube 8 includes a base 80 located between the locking member 7 and the room 51. The tubular portion 81 extends from the base 80 and protrudes beyond the locking member 7. The through hole 82 is defined through the base 80 and the tubular portion 81. A guiding unit 9 is located at the distal end of the material supply tube 8. The guiding unit 9 has an injection hole 90 defined therethrough, and the injection hole 90 communicates with the through hole 82. The hardness of the guiding unit 9 is not less than a hardness of the needle 60 of the needle valve 6. Specifically, the injection hole 90 of the guiding unit 9 includes a cone-shaped guiding face 91 formed in an inner periphery thereof, the cone-shaped guiding face 91 guides movement of the needle 60 of the needle valve 6. The guiding unit 9 further includes a shoulder 92 extending therefrom, and the material supply tube 8 is snugly mounted to the shoulder 92 to reinforce the connection the connection between the guiding unit 9 and the material supply tube 8.

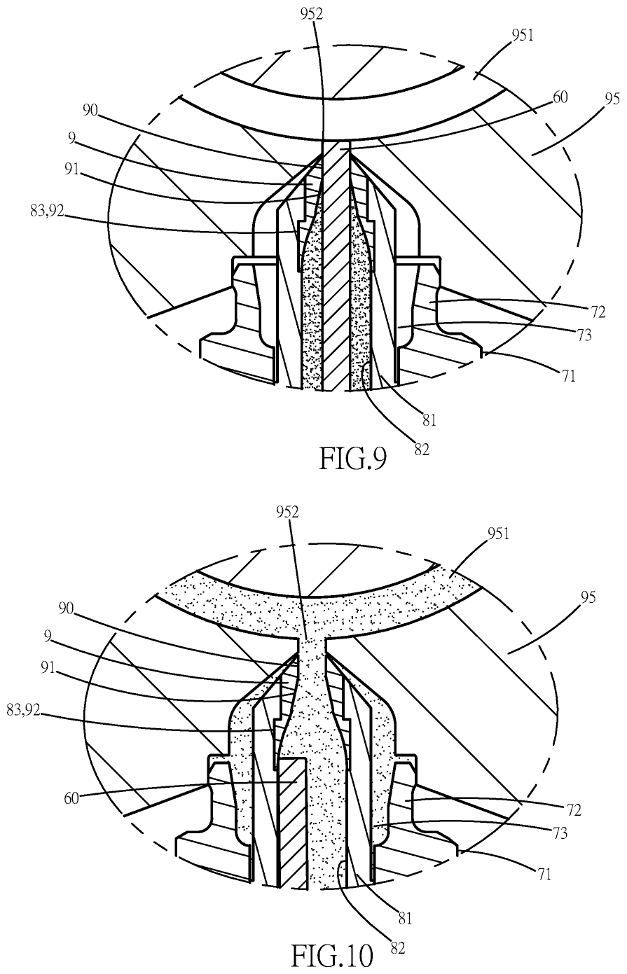

When proceeding the plastic injection molding, the distal end of the needle 60 of the needle valve 6 is moved backward and is located in the cone-shaped guiding face 91 of the guiding unit 9, such that the injection hole 90 is opened and the melted plastic material is easily supplied. When the melted plastic material touches the cone-shaped guiding face 91 of the guiding unit 9 and squeezes through the injection hole 90 and the inlet 950 of the mold set 95, and then flows into the cavity 951 of the mold set 95 to fill the cavity 951 as shown in FIG. 10. The needle 60 is then moved forward, because the hardness and the wearing resistance of the guiding unit 9 is larger than those of the material supply tube 8, and the hardness and the wearing resistance of the guiding unit 9 is not less than those of the needle 60, so that the distal end of the needle 60 moves along the inside of the cone-shaped guiding face 91 until it seals the injection hole 90. The distal end of the needle 60 is guided by the injection hole 90 so that it does not touch the inlet 950 of the mold set 95 as shown in FIG. 9. The injection hole 90 is not worn out and there will be no irregular portion formed on the products. The life of the material supply tube 8 is prolonged.

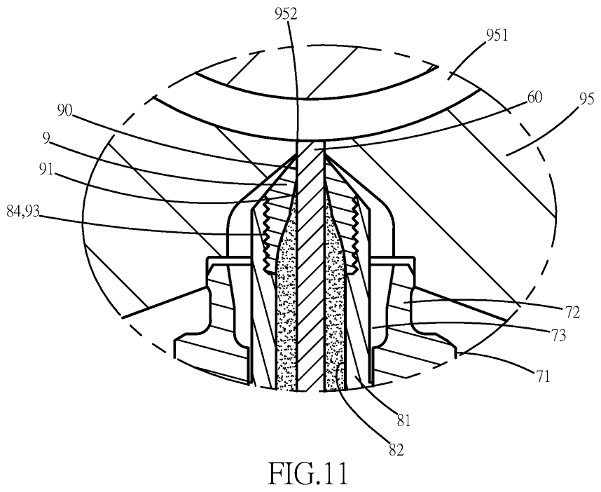

FIG. 11 shows another embodiment, wherein the guiding unit 9 includes a threaded portion 93 formed on the outer periphery thereof, and the material supply tube 8 includes a threaded section 84 defined in the inner periphery thereof. The threaded portion 93 of the guiding unit 9 is threadedly connected to the threaded section 84 of the material supply tube 8.

While we have shown and described the embodiment in accordance with the present invention, it should be clear to those skilled in the art that further embodiments may be made without departing from the scope of the present invention.

What is claimed is:

1. A movable needle valve of a hot-runner mold, comprising:
a body having a passage defined axially therethrough, a room defined in the body and communicating with the passage, a heating member mounted to outside of the body, a needle valve having a needle which is movably inserted into the passage, a locking member connected to the body, a material supply tube located between the locking member and the room in the body, the material supply tube including a base located between the locking member and the room, a tubular portion extending from the base and protruding beyond the locking member, a through hole defined through the base and the tubular portion, and a guiding unit located at a distal end of the material supply tube, the guiding unit having an injection hole defined therethrough, the injection hole communicating with the through hole, a hardness of the guiding unit being higher than that of the material supply tube, wherein when the needle moves within the guiding unit, the injection hole is not worn out by the needle.

2. The movable needle valve of a hot-runner mold as claimed in claim 1, wherein a wearing resistance of the guiding unit is higher than that of the material supply tube, the wearing resistance of the guiding unit is not less than a wearing resistance of the needle of the needle valve.

3. The movable needle valve of a hot-runner mold as claimed in claim 1, wherein the injection hole of the guiding unit includes a cone-shaped guiding face formed in an inner periphery thereof, the cone-shaped guiding face guides movement of the needle of the needle valve.

4. The movable needle valve of a hot-runner mold as claimed in claim 3, wherein the room includes inner threads defined therein, the locking member is threadedly connected to the inner threads of the room, the base of the material supply tube is clamped between the room of the body and a lower end of the locking member, the passage co-axially communicates with the through hole of the material supply tube.

5. The movable needle valve of a hot-runner mold as claimed in claim 4, wherein a distal end of the needle of the needle valve normally seals the injection hole of the guiding unit.

6. The movable needle valve of a hot-runner mold as claimed in claim 5, wherein the locking member includes outer threads which are threadedly connected to the inner threads of the room, the locking member has a flange extending outward and radially therefrom, an end lip axially extends from the flange, a space is defined axially through the locking member.

7. The movable needle valve of a hot-runner mold as claimed in claim 6, wherein the guiding unit includes a shoulder extending therefrom, the material supply tube is snugly mounted to the shoulder.

8. The movable needle valve of a hot-runner mold as claimed in claim 6, wherein the guiding unit includes a threaded portion formed on an outer periphery thereof, the material supply tube includes a threaded section defined in an inner periphery thereof, the threaded portion of the guiding unit is threadedly connected to the threaded section of the material supply tube.

9. The movable needle valve of a hot-runner mold as claimed in claim 7, wherein the hardness of the guiding unit is not less than a hardness of the needle of the needle valve.

10. The movable needle valve of a hot-runner mold as claimed in claim 8, wherein the hardness of the guiding unit is not less than a hardness of the needle of the needle valve.
